(19) United States
(12) Patent Application Publication
(10) Pub. No.: US 2026/0225323 A1
(43) Pub. Date: Aug. 6, 2026

(54) METHOD FOR ASSEMBLING AND DISASSEMBLING STRUCTURES

(71) Applicant: EXGINEERING SA, MANNO (CH)

(72) Inventor: SIMONE MACCAGNAN, CASTRONNO (VARESE) (IT)

(21) Appl. No.: 19/159,882

(22) PCT Filed: Mar. 23, 2023
(86) PCT No.: PCT/IB2023/052846

§ 371 Date: Aug. 26, 2025

(51) Int. Cl. B29C 65/76; B29C 64/141; B29C 65/02; B29K 105/00; B29L 31/10; B33Y 10/00; B33Y 30/00; B33Y 70/10

(52) U.S. Cl. CPC B29C 65/76; B29C 64/141; B29C 65/02; B33Y 10/00; B33Y 30/00; B33Y 70/10; B29K 2105/253; B29L 2031/10

(57) ABSTRACT

A method for assembling structures comprises the steps of arranging a spool of malleable wire, defining a wire deposition path to obtain a specific structure, and depositing the wire along the deposition path.

### DESCRIPTION

### Technical Field

The present invention relates to a method for assembling and a method for disassembling structures, as well as a system for implementing the assembly method and the disassembly method.

The term “structures” refers to all those basic structural elements adapted to define the skeleton of a building for temporary use, such as a trade fair pavilion: therefore, the present invention is in particular (but not limitedly) applied to the field of assembling and disassembling buildings for temporary use.

### State of the Art

In general, once the buildings are assembled and their period of use has elapsed, the temporary buildings are destroyed.

Depending on their actual use and on the materials used, there are problems in handling the different components. In particular, not all the components can be recovered and issues in managing wastes can lead to a considerable waste of resources.

### OBJECT OF THE INVENTION

The technical task of the present invention is therefore to make available an assembly method, a disassembly method and a system capable of overcoming the drawbacks arising from the prior art.

The object of the present invention is therefore to make available an assembly method, a disassembly method and a system that make it possible to quickly obtain structures intended for temporary use and their subsequent easy disassembly.

A further object of the present invention is therefore to make available an assembly method, a disassembly method and a system which may reuse the construction material for assembling future structures, further allowing, in addition to the obvious advantages, the use of better-performing materials, which are normally not used as they are expensive and difficult to source.

The specified technical task and the specified objects are substantially achieved by an assembly method, a disassembly method and a system comprising the technical features set forth in one or more of the attached claims. The dependent claims correspond to possible embodiments of the invention.

In particular, the specified technical task and specified objects are essentially achieved by a structure assembly method.

The method comprises a step of arranging a spool of wire which, in the jargon of the present invention, may conventionally be defined as “malleable”, i.e., which is susceptible to being modified in its geometric configuration and/or state of aggregation in order to be shaped and “directed” in a specific deposition or unwinding direction (and such deposition or unwinding direction will then define a part of the structure defined through the wire itself).

In order to better clarify the scope of the present invention, it should be noted that the range of “malleable wires” that may be used by the invention may, for example, include certain thermoplastic materials which are not purely malleable at room temperature, but become so when suitably heat-treated: possibly, the materials that meet this definition may generally be considered as (overall) thermoplastic polymers or even composite materials formed from carbon fibre (which is usually neither malleable nor thermoplastic) which is coated, still for exemplary purposes, with a suitably “malleable” polymer as understood in present invention (such as may be the so-called PEEK).

According to an aspect of the present invention, the step of arranging the spool thus involves arranging a spool of wire made at least partially of thermoplastic material or in any case having a “reversible” behaviour in the plastic coating/consolidation process (as exemplified above, such a material may possibly be formed in a composite form, i.e. it may be made of a material combined with continuous or discontinuous fibres of materials which are not necessarily thermoplastic).

According to an aspect of the present invention, the step of arranging the spool involves arranging a spool of wire comprising a core made of a resistant material and a surface portion made of malleable material.

According to an aspect of the present invention, the step of arranging the spool involves arranging a spool of wire having a core and a coating delimited to that core: conveniently, the core may be made of a continuous fibre of a first material, while the coating may be made of a second material, and the first material may be more “high melting” (i.e., may be more thermally resistant with respect to the plastic coating) than the second material.

According to an aspect of the present invention, the step of arranging the spool involves arranging a spool of wire in which the surface portion is made of thermoplastic material (or, in any case, the aggregation state of which can be reversibly reconfigured in its plastic coating/consolidation cycle), possibly in a composite form (i.e., such that it consists of a core composed of one or more fibres of materials that are not necessarily thermoplastic and covered by a coating with a substantially thermoplastic behaviour).

The method also includes a step of defining a path for depositing the wire to obtain a specific structure.

The deposition path comprises curving portions and path joining portions. According to an aspect of the present invention, the wire deposition path defines a three-dimensional design corresponding to the structure to be made.

Hence, the method involves carrying out a step of depositing the wire alon the deposition path: such a deposition step involves heating the wire to a softening temperature at the curving portions in order to shape said wire.

In other words, in the portions of the three-dimensional design corresponding to one or more edges of the structure, the wire is heated so as to make it malleable and deformable in order to follow the desired structure.

In addition, the deposition step involves heating the wire to a melting temperature at the joining portions to join different portions of the deposited wire. In other words, at edges and/or portions wherein the structure overlaps and/or joins, the wire is heated so that it is joined to already deposited portions of wire.

According to an aspect of the present invention, the step of heating the wire to a softening temperature is carried out by heating the wire to a temperature between 20° C. and 500° C.

According to an aspect of the present invention, the step of heating the wire to a melting temperature is carried out by heating the wire to a temperature between 30° C. and 600° C.

According to an aspect of the present invention, the step of defining the deposition path is carried out by defining structural lattices placed side by side to each other to define the structure.

According to an aspect of the present invention, in the step of defining the deposition path, one or more curving portions coincide with said joining portions.

The specified technical task and the specified objects are also achieved by a method of disassembling a structure made by an assembly method according to one or more of the aspects of the present invention.

The disassembly method comprises the steps of heating the wire to a temperature suitable for separating the joined wire portions, heating the wire to a temperature suitable for straightening and rectifying the surface of the shaped wire portions, and rewinding the wire spool.

The heating steps (and collection steps, i.e., the recovery of the wire that previously made up the structure, which is disassembled, making the wire “malleable” again) are carried out by following the deposition path of the wire spool backwards.

According to an aspect of the present invention, the disassembly method comprises a step of arranging an annular body suitable for fitting the wire. In addition, the method involves sliding the annular body along the wire following said deposition path backwards and heating the annular body to separate the joined wire portions and/or straighten and rectify the surface of the shaped wire portions.

The specified technical task and specified objects are further achieved by a system for assembling and disassembling a structure, comprising a robotic system provided with heating means and adapted to perform one or more of the steps of the assembly method according to one or more of the aspects of the present invention and adapted to perform one or more of the steps of the disassembly method according to one or more of the aspects of the present invention.

Further characteristics and advantages of the present invention will become clearer from the indicative and therefore non-limiting description of an embodiment of an assembly method, disassembly method and a system.

### BRIEF DESCRIPTION OF THE DRAWINGS

Such description will be set forth herein below with reference to the accompanying drawings, provided for merely indicative and therefore non-limiting purposes, wherein:

FIG. 1 and FIG. 2 are different structures obtained by the method that is the object of the present invention;

FIGS. 3A and 3B are different embodiments of a wire for implementing structures.

### DETAILED DESCRIPTION OF PREFERRED EMBODIMENTS OF THE INVENTION

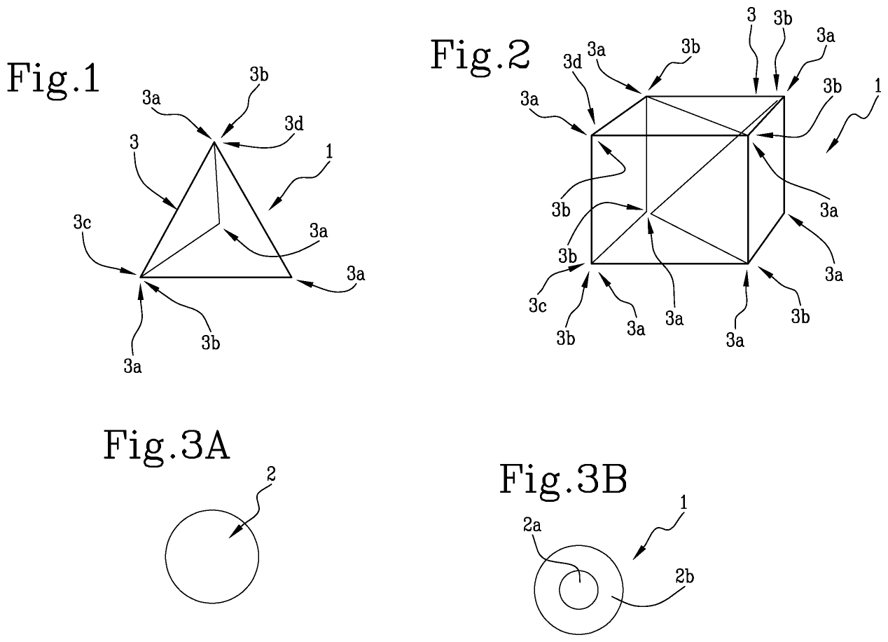

FIG. 1 and FIG. 2 show two structures 1 obtained by an assembly method that is an object of the present invention.

The term structures 1 refers to all those basic structural elements that are adapted to define the skeleton of a building or premise for temporary use, such as a pavilion of a trade fair or the basic structure for a sculpture.

The method comprises a step of arranging a spool of malleable wire 2.

According to one aspect of the present invention, the step of arranging the spool involves arranging a spool of wire 2 made of PEEK, PA or PP. In other words, the method involves arranging a spool of wire 2 in which the wire 2 itself is made of a single material, as depicted in FIG. 2A.

According to an aspect of the present invention, the step of arranging a spool involves arranging a spool of wire 2 comprising a core 2a of resistant material and a surface portion 2b made of malleable material as shown, for example, in FIG. 2B.

According to an aspect of the present invention, the step of arranging the spool involves arranging a spool of wire 2 in which the core 2a is made of LCP, carbon, glass, metal or basalt fibre.

According to an aspect of the present invention, the step of arranging the spool involves arranging a spool of wire 2 in which the surface portion 2b is made of PEEK, PA or PP.

The method also comprises a step of defining a deposition path 3 of the wire in order to obtain a specific structure 1: such a deposition path 3 may conveniently comprise, depending on the contingent needs, one or more curving portions 3a and joining portions 3b of the deposition path 3.

According to an aspect of the present invention, the deposition path 3 of the wire 2 defines a three-dimensional design corresponding to the structure to be obtained.

According to an aspect of the present invention, in the step of defining the deposition path 3 one or more curving portions 3a coincide with the joining portions 3b.

In particular, the deposition path 3 comprises an initial deposition portion 3c and a final deposition portion 3d.

In addition, the deposition path 3 comprises straight portions interposed between the different curving portions 3a and the initial 3c and final 3d deposition portions.

Preferably, one or more joining portions 3b may coincide with the initial deposition portion 3c and/or with the final deposition portion 3d.

Preferably, the initial deposition portion 3c can coincide with the final deposition portion 3d.

Preferably, the deposition path 3 is defined in such a way that there are no portions of wire 2 occupying the inner volume of the structure 1. In other words, the deposition path 3 is defined in such a way that the wire 2 is only deposited on superficial portions of the final structure 1.

In FIG. 1 and FIG. 2, for simplicity of representation, the joining portions 3b have been globally indicated where present but not actually represented. According to an aspect of the present invention, the step of defining the deposition path 3 is carried out by defining structural lattices placed side by side to each other to define the structure 1.

For example, FIG. 1 shows a deposition path 3 defining a pyramid-shaped structure 1 in which the upper edge simultaneously defines a curving portion 3a, a joining portion 3b and the final deposition portion 3d.

FIG. 2 shows a deposition path 3 defining a cubic structure 1.

Hence, the method involves a step of depositing the wire 2 along the deposition path 3.

Such a step involves heating the wire 2 to a softening temperature at the curving portions 3a to shape the wire 2. In other words, in the portions of the three-dimensional design corresponding to one or more edges of the structure 1, the wire 2 is heated so as to make it malleable and deformable in order to follow the desired structure.

In case the wire 2 is made of a single material as in FIG. 3A, this heating step is carried out so as to soften only a surface portion of the wire 2.

In case the wire 2 has a core 2a and a surface portion 2b as in FIG. 3B, such a heating step is carried out at a temperature suitable for softening only the surface portion 2b of the wire 2 itself so as not to affect the core 2a. In addition, the deposition step involves heating the wire 2 to a melting temperature at joining portions 3b to join different portions of deposited wire 2. In other words, at edges and/or portions where the structure 1 overlaps and/or joins, the wire 2 is heated so as to join it to portions of wire 2 that have already been deposited.

According to an aspect of the present invention, the step of heating the wire 2 to a softening temperature is carried out by heating the wire 2 to a temperature between 20° C. and 500° C. (e.g., depending on particular material choices, the temperature range just mentioned may be between 60 °C. and 300° C.).

According to an aspect of the present invention, the step of heating the wire 2 to a melting temperature is carried out by heating the wire 2 to a temperature between 30° C. and 600° C. (e.g., depending on particular material choices, the temperature range just mentioned may be between 150° C. and 450° C.).

The present invention also relates to a method of disassembling a structure 1 made by an assembly method as described above.

The disassembly method comprises the steps of heating the wire 2 to a temperature suitable for separating the joined portions of wire 2, a step of heating the wire 2 to a temperature suitable for straightening and rectifying the surface of the shaped portions of wire 2, and a step of rewinding the spool of wire 2.

In other words, the disassembly method involves separating the joining portions 3b and straightening and rectifying the surface of the curving portions 3a in order to restore the wire 2 to its original pre-assembly condition.

The heating steps are carried out by following the deposition path 3 of the spool of wire 2 backwards.

According to an aspect of the present invention, the disassembly method comprises a step of arranging an annular body suitable for fitting the wire 2. In addition, the method involves sliding the annular body along the wire 2 following the deposition path 3 backwards and heating the annular body to separate the joined portions of the wire 2 and/or straighten and rectify the surface of the shaped portions of wire 2.

In other words, the disassembly method is carried out by means of the annular body which, once fitted on the wire 2, is slid on the wire 2 and brought to a suitable temperature to separate the joining portions 3b and straighten and rectify the surface of the curving portions 3a.

The present invention also relates to a system for assembling and disassembling a structure 1.

The system comprises a robotic arm provided with heating means and adapted to perform one or more of the steps of the assembly method as described above and adapted to perform one or more of the steps of the disassembly method as described above.

In other words, the robotic arm is provided with at least one depositing device adapted to deposit the wire 2 along the deposition path 3. In addition, the robotic arm is provided with a device for separating the joining portions 3b and a device for straightening and rectifying the surface of the curving portions 3a. Preferably, the robotic arm is provided with the annular body. In other words, the system makes it possible to construct and deconstruct using a hybrid system based on an “additive manufacturing” processing plant.

Advantageously, the present invention is able to overcome the drawbacks arising from the prior art.

Advantageously, the present invention makes it possible to build and dismantle structures 1 with no need to recycle the material as it is reused. This is beneficial in environmental, economic and regulatory terms, as it does not lead to the raw material becoming waste at the end of its use, thus avoiding the risk of onerous management procedures due to current bureaucratic and regulatory apparatus.

Advantageously, it is possible to recover the wire 2 by winding the wire 2 onto a spool waiting to be reused.

Advantageously, by means of the present invention, it is possible to build temporary lattice structures 1.

1. A method for assembling structures comprising the steps of:
arranging a spool of malleable wire;
defining a deposition path of said wire to implement a specific structure, said deposition path comprising curving portions and joining portions of the deposition path of the wire; and
depositing said wire along said deposition path, wherein said deposition step comprises the sub-steps of:
heating said wire to a softening temperature at said curving portions to shape said wire; and
heating said wire to a melting temperature at said joining portions to join different portions of deposited wire.

2. The assembly method according to claim 1, wherein said step of heating the wire is carried out by heating the wire to a softening temperature between 20° C. and 500° C.

3. The assembly method according to claim 1, wherein said step of heating the wire is carried out by heating the wire to a melting temperature between 30° C. and 600° C.

4. The assembly method according to claim 1, in which said step of defining the deposition path is carried out by defining structural lattices placed side by side to each other to define said structure.

5. The assembly method according claim 1, wherein in said step of defining the deposition path one or more curving portions coincide with said joining portions.

6. The assembly method according to claim 1, wherein said step of arranging the spool of wire involves arranging a spool of wire made of PEEK and/or PA and/or PP.

7. The assembly method according to claim 1, wherein said step of arranging a spool of wire involves arranging a spool of wire comprising a core of resistant material and a surface portion of malleable material.

8. The assembly method according to claim 7, wherein said step of arranging a spool of wire involves arranging a spool of wire wherein said core is made of at least one of PEEK, PA and PP, and wherein said surface portion is made of at least one of LCP, carbon, glass, metal and basalt fibre.

9. A method of disassembling a structure made by an assembly method according to claim 1, comprising the steps of:
heating the wire to a temperature suitable for separating the joined portions of wire;
heating the wire to a temperature suitable for straightening and rectifying the surface of the shaped portions of wire; and
rewinding said spool of wire, said heating steps being performed by following said depositing path the spool of wire backwards.

10. The disassembly method according to claim 9, further comprising the steps of:
arranging an annular body suitable to fit said wire;
sliding said annular body along said thread following backwards said deposition path; and
heating said annular body to separate said joined wire portions and/or straighten and rectify the surface of said shaped wire portions.

11. A system for assembling and disassembling a structure, comprising a robotic system, comprising a robotic arm, provided with heating means and adapted to carry out one or more of the steps of the assembly method according to claim 1.
